(19) United States
(12) Patent Application Publication
(10) Pub. No.: US 2021/0125586 A1
(43) Pub. Date: Apr. 29, 2021

(54) PANEL BOARD FOR MUSICAL INSTRUMENT

(71) Applicant: Robert L. Oberg, Syosset, NY (US)

(72) Inventor: Robert L. Oberg, Syosset, NY (US)

(21) Appl. No.: 17/078,673

(22) Filed: Oct. 23, 2020

Related U.S. Application Data
(60) Provisional application No. 62/924,981, filed on Oct. 23, 2019.

(51) Int. Cl. G10D 3/02; G10D 1/08

(52) U.S. Cl. CPC G10D 3/02; G10D 1/08

(57) ABSTRACT

A musical instrument comprising a body having a front board representing the front surface thereof, a backboard representing the rear surface thereof, a common hollow or semi-hollow interior extending between the front board and the backboard, and a panel board comprising a frame. The frame has a top plate, a bottom plate, a first side and a second side forming a closed unit and at least one slat is disposed within the frame. The panel board conforms to the front board and/or the backboard. The slat may be a single pane or honey comb and shaped to be serpentine, s-shaped, I-beam shaped. In an embodiment, there are at least two slats.

### PRIORITY CLAIM

This application is based upon and claims the benefit of priority from the U.S. Provisional patent application No. 62/924,981, entitled Serpentine Panel Board, filed on Oct. 23, 2019, the entire contents of which are incorporated herein by reference.

### FIELD OF THE INVENTION

The present disclosure is directed to stringed musical instruments specifically to a strengthened musical instrument body structure improving sound vibrations therein.

### BACKGROUND OF THE INVENTION

Conventional stringed musical instruments which have a hollow or semi-hollow body generate musical tones by strumming or plucking strings stretched over a bridge and saddle mounted on the sound board corresponding to the anatomical front of the musical instrument. Sound is produced by the vibration of the strings and transmitted from a bridge assembly, mounted upon the sound board, throughout the body of the musical instrument and exits through a sound hole in the musical instrument, generally located in the anatomical front sound board and usually underneath the strings.

Guitars are one example of stringed musical instruments. In an acoustical guitar the hollow interior of the body forms an acoustical resonant enclosure which enhances and amplifies the sound generated from the sound board. The sound board of the musical instrument is conventionally understood to represent the top or front board of the instrument. Traditionally, the rear or backboard of the guitar is not considered to have much, if any, significance relative to the overall sound generated by the musical instrument and, as such, little attention is given to the wood used in the construction of the backboard of the guitar.

The front board and backboard are connected to the body of the instrument along the sides thereof to fully enclose the body surrounding the hollow interior. As explained above, the front board is recognized as the sound board of an acoustical guitar and is composed of expensive tone woods such as, for example, spruce and/or red cedar whereas the backboard is typically composed of inexpensive wood or other material.

The front board and backboard of a conventional acoustical guitar usually includes ribs on the inner side of each board facing the interior of the guitar to add to the structural strength of each board respectively.

Care must be taken in forming an instrument body to prevent poor sound quality and natural deterioration due to warping or damping over time. Thin bodies can result in an easily damageable instrument especially when exposed to light impacts. Tension from strings of the instrument will eventually result in bending, cracking or other damage to the front board of the body. Such damage can affect the structure of the instrument and result in poor tonal quality from the instrument.

It is known that a sufficiently stiff guitar backboard strengthens the body of the instrument. This stiffness contributes to the structural support and maintains pitch and sound to increase acoustic performance of the musical instruments as well as strength of the instrument. In contrast, warped or disfigured backboards deteriorates the overall sound of the music instrument over time. Often backboards are made of heavier woods for strength as opposed to addressing the sonic quality of the front board.

Thus, it is desired to have the sound produced from a stringed musical instrument be enhanced by strengthening the body of the guitar. It is desired to have structural support within the front board and/or backboard of the guitar to enhance and augment traditional instrument supports. It is desired to have a musical instrument body structurally sound simultaneously strong and supportive which imparts improved sound quality. It is further desired to have the front sound board and the rear board (backboard) of the guitar serve as sound boards simultaneously.

### SUMMARY OF THE INVENTION

A musical instrument comprises a body having a front board, a backboard forming a common hollow or semi-hollow interior and a panel board comprising a frame. The frame has a top plate, a bottom plate, a first side and a second side forming a closed unit and at least one slat is disposed within the frame. The panel board conforms to the front board and/or the backboard. The slat may be a single pane or honey comb and shaped to be serpentine, s-shaped, I-beam shaped. In an embodiment, there are at least two slats.

### DESCRIPTION OF THE DRAWINGS

FIG. 1 shows an exploded view of a musical instrument of the present invention in accordance with aspects of embodiments of the invention;

FIG. 2 shows internal features of the panel board for musical instrument;

FIG. 3 shows a single serpentine slat;

FIG. 4 shows an “I” beam slat; and

FIG. 5 shows a honeycomb panel board.

### DETAILED DESCRIPTION OF THE INVENTION

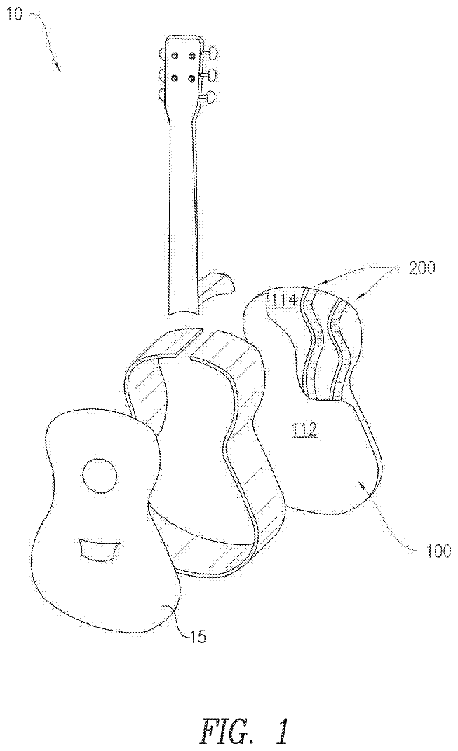

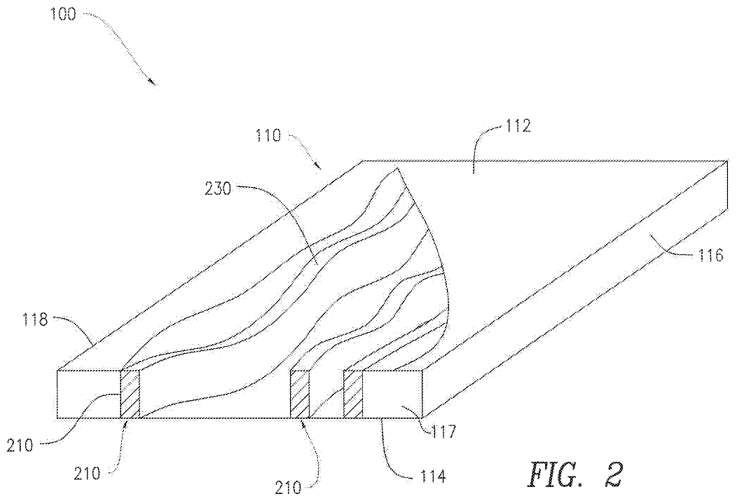

The present invention provides a musical instrument, 10 such as an acoustic guitar, with a panel board 100. See FIG. 1. Referring to FIG. 2, the panel board 100 of the present invention comprises a closed unit frame 110 comprising top and bottom plates 112 and 114, respectively and first and second sides 116 and 118, respectively, along with end caps 117. In some embodiments, plates 112 and 114 are parallel to each other, sides 116 and 118 are parallel to each other and end caps 117 are also parallel to each other. In other embodiments, only one plate 112, or 114 may be employed.

In one embodiment, the panel board 100 is largely hollow and shaped to conform to the soundboard or backboard of the instrument. For instance, the panel board 100 may be dimensioned and configured to form the backboard as shown in FIG. 1. Alternatively, panel board 100 may be formed as a separate plate that is inserted inside the guitar to be fixedly attached to the front board 15 and/or backboard. Thus, when used with a banjo, the panel board may be circular and if used with a matchbox guitar, the panel board 100 would conform in a like shape.

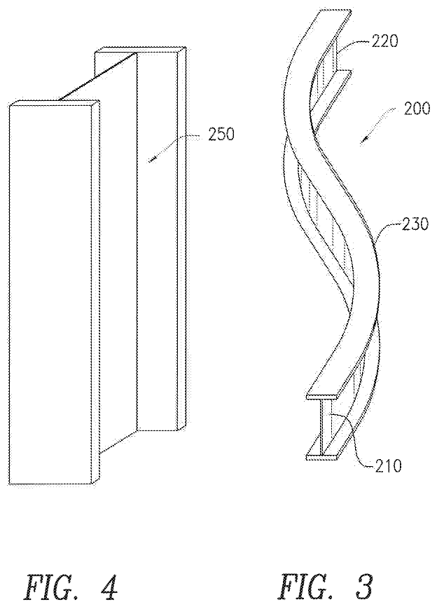

At least one slat 200 is disposed within the panel board 100. The slat 200 shown in FIGS. 1-3 has a first or lower end 210 and a second or upper end 220 with a serpentine body 230. The serpentine body 230 is convoluted or “s” shaped 230 in configuration. The slat 200, when serpentine in form, has a serpentine body 230 that provides continuous contact with the top and bottom plates 112 and 114. See FIG. 2. These multiple contact points provide overall greater strength in the frame 110 of the panel board 100.

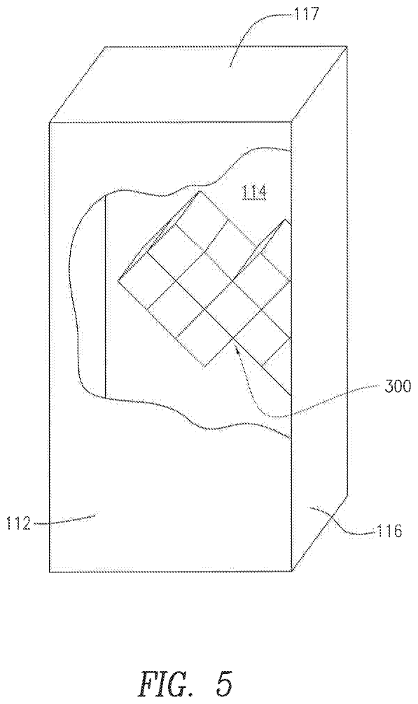

In another embodiment, the slat may take an “I” beam type orientation or design. See FIG. 4. In yet another embodiment, see FIG. 5, the board 100 may comprise a honey comb slat 300 that are oriented in a serpentine configuration or any supportive design. The honey comb slat 300 design comprises individual box-like units. The slat 200 may be a single pane or honey comb and shaped to be serpentine, s-shaped, I-beam shaped. In an embodiment, there are at least two slats.

The panel board 100 can be used in construction in lieu of any panel or plywood, for instance. The board 100 could be used to construct the body of musical instruments anywhere where additional support or strength is needed. For instance, the panel board 100 could be used to construct the backboard, see FIG. 1. In other embodiments, the panel board 100 conforms and is integrated with the front board 15. In another embodiment, the panel board 100 conforms and is integrated with both the front board 15 and the backboard.

By replacing the backboard and/or the sound board 15 with the panel boards 100, the overall instrument body, would be stronger than traditional musical instruments bearing single-ply plates. In the embodiments, where only one plate 112, or 114 is employed, the panel board 100, may be cut into the shape of guitar 10 and added inside the front board 15 or backboard to make the body of the guitar stronger. In an embodiment, the panel board 100 may be continuous and range in thicknesses. In one embodiment, the panel board 100 may be about ¾″ to about 1″ thick. The present invention permits the lighter and quality materials be used with the instrument compared to prior art inventions.

Traditionally musical instruments such guitars, violins and the like use top and bottom arched plates. These plates are single layers of wood or similar material that are commonly known to require internal braces such as x-braces, side braces, treble braces and the like. In the case of violins bass bars and the like are used. By using the panel board 100 to construct these aforementioned instruments, strength is added to the overall construction of the musical instrument. As a result of the present invention such prior art braces are not needed. By employing the panel board 100 or, alternatively, employing the slat 200 in musical instruments, cables or wires can be run within the slat 200.

While specific embodiments of the invention have been described and illustrated, such embodiments should be considered illustrative of the invention only and not as limiting the invention as construed in accordance with the accompanying claims. One of ordinary skill in the art could alter the above embodiments or provide insubstantial changes that may be made without departing from the scope of the invention.

I claim:

1. A musical instrument comprising:
a body having
a front board representing the front surface thereof,
a backboard representing the rear surface thereof,
a common hollow or semi-hollow interior extending between the front board and the backboard; and
a panel board, said panel board comprising a frame, said frame comprising a top plate, a bottom plate, a first side and a second side forming a closed unit, and at least one slat disposed within the frame.

2. The musical instrument of claim 1 wherein the panel board conforms to the backboard.

3. The musical instrument of claim 2 wherein the panel board conforms to the front board.

4. The musical instrument of claim 1 wherein the slat is serpentine.

5. The musical instrument of claim 1 wherein the slat is s-shaped.

6. The musical instrument of claim 1 wherein the slat is I-beam shaped.

7. The musical instrument of claim 1 wherein the slat is honey comb shaped.

8. The musical instrument of claim 7 wherein the honey comb slat is s-shaped.

9. The musical instrument of claim 1 wherein there are at least two slats.
